(19) United States
(12) Patent Application Publication
(10) Pub. No.: US 2003/0233410 A1
(43) Pub. Date: Dec. 18, 2003

(54) Electronic carbon copy dissemination control

(75) Inventors: Carl Phillip Gusler, Austin, TX (US); Rick Allen Hamilton II, Charlottesville, VA (US); Michael Edward Schwartz, Rockville, MD (US); Timothy Moffett Waters, Richmond, VA (US)

Correspondence Address: Robert H. Frantz, P.O. Box 23324, Oklahoma City, OK, 73123, US

(73) Assignee: International Business Machines Corporation, Armonk, NY

(21) Appl. No.: 10/165,142

(22) Filed: Jun. 6, 2002

(51) Int. Cl. G06F 15/16

(52) U.S. Cl. 709/206

(57) ABSTRACT

A system and method for providing control by and author over the dissemination of information contained in a blind carbon copy electronic message. The author may specify whether or not a BCC recipient may reply to the author, reply to any of the other message recipients, forward the message, copy, save or print the message. If a BCC recipient attempts to perform a controlled dissemination action, the author may elect to be notified of the attempt, to notify the BCC recipient of the surveillance, and to optionally authorize the performance of the dissemination operation. Additionally, the author may delay the performance of the dissemination action according to a schedule or time delay specified by the author.

### BACKGROUND OF THE INVENTION

1. Field of the Invention

This invention relates to the technologies of electronic messaging and capabilities to forward messages and copy messages to secondary and subsequent recipients. This invention relates more specifically to control abilities to permit or deny a recipient of a message to forward a copy of a message or copy the message to subsequent recipients.

2. Background of the Invention

Electronic mail and electronic messaging have become key and integral to everyday life, both in personal lives and business operations, for millions of users worldwide. The speed and accuracy with which electronic messages and e-mails are delivered is unrivaled by other forms of messaging, such as paper mail, overnight express mail, facsimile, and voice messaging.

Prior to the widespread proliferation of the Internet and Internet-based e-mail, there were many proprietary formats of electronic messaging systems, such as IBM's Lotus Notes system, Novel's DaVinci system, and others.

However, due to global acceptance and adoption of the Internet, the Internet's e-mail protocol has become the most common electronic messaging protocol in use today. The Simple Mail Transfer Protocol (“SMTP”) provides for a quick, error-free and robust method for transferring electronic messages from one e-mail server to another. SMTP is primarily based upon two standards proliferated by the Internet Architecture Board (“IAB”), specifically RFC-821 “Simple Mail Transfer Protocol” and RFC-822 “Standard for the format of ARPA Internet text messages”.

These standards and protocols are well-known in the art. RFC-821 describes the protocol used for transferring electronic messages from one server to another, and RFC-822 describes a corresponding format for those electronic messages.

Turning to FIG. 1, the basic arrangement of client browser computer or client e-mail computers and web servers is shown. A client computer (1) may access a web-based e-mail server (5) via any computer network, such as the World Wide Web (3), or an Intranet (6) such as a LAN or WAN. This access may be made through a modem and a dial-up Internet Service Provider (“ISP”), or through a “dedicated” direct connection to the Internet. The client computer (1) is normally equipped with an e-mail composer and reader program, such as Qualcomm's Eudora, Netscape's Messenger, or Microsoft's Outlook programs. These and many other widely available programs are compliant with the SMTP standards, and interoperate with e-mail servers over computer networks such as the World Wide Web.

Turning to FIG. 2, the arrangement (20) as defined by the RFC's of a sender server (23) and a receiver server (25) using the SMTP protocol is shown. A user (21) may author a SMTP-compliant message and send that message to an e-mail sender server (23). Using a series of SMTP commands (24) which are communicated to a receiver SMTP server (25) via a computer network, the electronic message is transferred from the sender SMTP (23) to the receiver SMTP server (25).

The receiver SMTP (25) server typically stores the received electronic message within its file system (26) for later retrieval by the intended recipient. The addressing and routing scheme used by e-mail servers to transmit and route electronic messages to each other using of this protocol are well-known within the art, and are also defined in the public RFC documents of the IAB.

Eventually, the recipient uses his computer (28) to download the messages from the receiver server (25), and to read, reply, or forward the messages. His computer (28) is usually equipped with e-mail reading and authoring software, which may include an e-mail address book (27).

A useful function of common e-mail composers and readers available in the art today is that of an address book (27, 203). An address book stores names and e-mail addresses of other users who are commonly communicate with the user. Most e-mail composers and readers also include automatic functions for adding a message sender's address and information to an address book.

The generalized message format of an electronic message is shown in Table 1. An electronic message is typically divided into two portions, a header and a body. Within the header are multiple tags or fields which indicate the source and destination of the message and other useful information.

TABLE 1
Generalized Electronic Message Format

Received: from source by local_server; time_of_day
From: senders_name <senders_email_address>
Reply-to: <senders_email_address>
To: recipients_name <recipients_email_address>
Subject: text_of_the_subject_line
Content-type: type_of_content_such_as_MIME
“Text of the actual message”

In the example generalized message format shown in Table 1, there is a “Received” header field, a “From” header field, a “Reply-To” field, and a “To” field. These are also followed by a “Subject” field and then finally by the text of the actual message. These fields are generated by the e-mail composer on the originator's computer (21), and they are used by the various e-mail servers (23, 25, etc.) within the computer network to route the messages to the correct recipient.

As shown in Table 1, the “Received:” message header field shows information regarding which server received the message and at what time of day it was received by the local server. The “From” field in the message header shows the originator's or the sender's name and address. The “Reply-To” field shows the sender's e-mail address for use in replying to the sender. The “To” field shows the intended recipient's name and/or recipient's e-mail address. And, the “Subject” field shows a text string to be displayed when the e-mail is viewed among other e-mails in a mail box.

Most e-mail composer and reader programs allow messages to be forwarded to second, third, and subsequent recipients, as illustrated in FIG. 2. For example, a first sender (21) may author an original message and send it to a first recipient (28). The first recipient (28) may read that message, append comments to it, and forward (204) it to a subsequent recipient (202). The protocol used to forward (204) a message is generally the same as the protocol used to originally send (24) the message from the author (21) to the first recipient (28), with the main differences being in the format of the message itself which is typically modified to indicate which text is original message text and which text is added comments by the forwarder.

Table 2 shows a generalized message format for forwarded electronic messages which uses using a method of forwarding called “inline content”.

TABLE 2
Generalized Forwarded Electronic Message Format
using Inline Type of Forwarding

Received: from source by local_server; time_of_day
From: first_recipients_name <first_recipients_email_address>
Reply-to: <first_recipients_email_address>
To: second_recipients_name <second_recipients_email_address>
Subject: FWD:text_of_the_subject_line_written_by_the_originator
Content-type: type_of_content_such_as_MIME
Content-disposition: inline
“Text of the message written by the first recipient intended for the

second recipient”

Boundary_tag
Received: from source by local_server; time_of_day
From: originator_name <originators_email_address>
Reply-to: <originators_email_address>
To: first_recipients_name <first_recipients_email_address>
Subject: FWD:text_of_the_subject_line_written_by_the_originator
Content-type: type_of_content_such_as_MIME
“>Text of the actual message written by the originator and intended for the
>first recipient”
Boundary_tag

This forwarded message format resembles the generalized message format of Table 1, especially in the initial message header, including the “received” field, “from”, “reply-to”, “to”, and “subject” fields. However, most programs modify the text contained in the “subject” field to include an indication that this is a forwarded message, such as appending the letters “FWD” prior to the actual text of the originator's subject line. Following this message header, the text of the comments authored by the first recipient and intended for the second recipient are given. Then, according to the inline forwarding method, a boundary tag is given which indicates the beginning of the actual forwarded message.

Following the first boundary tag, another set of message header fields are shown which are the message header fields from the original message from the original sender of the message. These message fields are then followed by the text of the original message from the originator, which is typically modified to indicate it is the original text of the forwarded message, such as by placing a “>” character or vertical bar in the first column of each line. This forwarded message is concluded by a closing boundary tag.

Another method for forwarding an electronic message to another recipient is by “attaching” the original message to the new message. The SMTP protocol allows for files of all types to be “attached” to an electronic message, and as such, one method for forwarding a message is to create a new message to the next recipient, and to attach the old message to this new message. As shown in Table 3, the general format of a forwarded message as an attachment is seen.

TABLE 3
Generalized Forwarded Electronic Message Format
using Attachment Type of Forwarding

Received: from source by local_server; time_of_day
From: first_recipients_name <first_recipients_email_address>
Reply-to: <first_recipients_email_address>
To: second_recipients_name <second_recipients_email_address>
Subject: FWD:text_of_the_subject_line_written_by_the_originator
Content-type: type_of_content_such_as_MIME
Content-disposition: inline
Text of the message written by the first recipient intended for the second

recipient

Start-of-attachment-tag

Received: from source by local_server; time_of_day
From: originator_name <originators_email_address>
Reply-to: <originators_email_address>
To: first_recipients_name <first_recipients_email_address>
Subject: FWD:text_of_the_subject_line_written_by_the_
originator
Content-type: type_of_content_such_as_MIME
“>Text of the actual message written by the originator and intended
>for the first recipient”

End-of-attachment-tag

This message begins similarly to the message in Table 2 in that it is preceded by a new message header containing multiple header fields, including the “received”, “from”, “reply-to”, “to”, “subject” fields. However, in this case following the text of the comments written by the first recipient for the second recipient, there are special tags to indicate that there is attached file rather than the inline copy of the forwarded file. This may be the same type of tag that may be used to attach a data file or other type of file to the electronic message, but in this case the attached file is simply a text file which is actually the original message from the originator.

Thus, if one looks within that attached file, one will see that there is the original set of message header tags which indicate the originator's name, the first recipient's name (or the previous recipient's name) and other useful information regarding the previous message.

A third method of forwarding e-mail messages is by “quoting” the actual message into the text of the new message intended for the next recipient. In this method, none of the previous header fields are forwarded to the next recipient. A simple line of text such as “Previous_recipient wrote:” may be inserted above the quoted text, and the quoted text may be set apart such as using a character such as “>” or a blue bar in the left margin.

A subsequent recipient may choose to forward the message to another recipient, thereby forming a chain-forwarded message which may have the original message forwarded through a combination of methods.

All of these message header fields are used for various functions of the e-mail reader and e-mail composer software. If a user wants to reply to the sender of a message he may simply click or select a “reply” function in response to which the composer will be invoked and will automatically address the message to the address indicated in the “reply-to” field of the message. Also, the user may forward the message quite simply by clicking a “forward” button (or otherwise invoking a forward function), which causes the composer to allow creation of a new message containing or attaching the first message, and giving the user the capability to enter the next subsequent recipient's address, as well as any comments he or she wishes to include.

When originally sending a message, and author has several options or types of original recipients. The “overt” recipients are listed in the “TO:” field. Copies may be sent for the convenience of other persons by placing their addresses in the carbon copy “CC:” field. The “CC:” field is often used to keep other parties, such as managers or associated, “in the loop” or informed of transactions in a conversation, but where the “CC:” recipients are not usually expected to reply (although the protocol provides for the same reply addressing as the recipients in the “TO:”).

Similar in operation to the “CC:” field is the blind copy “BC:” field, through which message authors may enter recipients' addresses to whom a copy is to be sent, but whose addresses are to be blocked from view by the other recipients listed in the “TO:” and “CC:” fields. Blind carbon copying (“BCC”) permits the hidden recipients to witness an exchange of information or dialogue between parties, so that the hidden recipient may gain insight without the knowledge of the nominal recipient. In other cases, BCC gives the sender the ability to send a message to large lists of people, without documenting all who received it. This latter benefit of the BCC email process can be useful in keeping a recipient of a message from obtaining all of the email addresses in the author's sending list or group.

BCC, however, poses several problems for the sender. Firstly, anyone in receipt of the message can easily forward it on to other parties. This could be extremely detrimental if the message contains sensitive information, or if the author would for some reason wish for the recipient of the forwarded message not to receive it.

For example, corporate mass emails to employees disclosing end of quarter results could strongly affect stock prices if news of poor performance leaked out to the public. These “official” corporate documents could then be modified by outside parties intending to damage the company. Once it email was present in the “open”, it could rapidly be spread to thousands of other recipients.

Secondly, if an original (intended) recipient replies to the email but accidentally uses a “Reply to All” function (which addresses the reply message not only to the author but all other recipients of the original message), all those who initially received the email may see the response. This could leave the author in a precarious situation, in that something embarrassing sent in return can be viewed by all in the mailing list through a simple mistake on the part of a recipient.

In summary, the sender, in choosing to transmit a BCC note, is exposing himself or herself to potentially damaged relationships with the nominal recipient, as well as serious financial loss, depending on the subject and sensitivity of the message.

Though not strictly deceitful, an implicit trust may exist between the sender and nominal recipient. This trust may, in turn, be damaged if the overt recipient(s) in the “TO:” list learns that others were called to witness (via the BCC) what he or she thought was a private exchange of information. Ultimately, of course, this breach of trust may damage working relationships, and endanger the productivity of the persons involved.

According to current email authoring technologies, when the sender wishes to send out an e-mail and utilize the blind carbon copy functionality, he or she fills out the “BCC” field with the desired recipients of the message. In some cases, the “TO:” field must contain an address, as some mail servers may reject a message with blank “TO:” field. Outside of that, there is nothing else for which the sender is typically prompted in creating a BCC message—the email authoring client program neither warns the author of the perceived risk, nor prompts the author with options to mitigate that risk.

Without any explicit warning or prompting, the author will go about business as usual, and the email, and its corresponding and underlying trusts and relationships, will be susceptible to unlimited risk. A good example of the security flaw exhibited by most available email authoring client software is the susceptibility to certain types of computer intrusion techniques, such as worms, viruses and Trojan horses. Many of these programs cause a message to be transmitted from a victim's email client to all of the entries in a recipient's address book. So, for example, if an author creates a sensitive message and sends it to a BCC recipient who has an infected client, the intrusion program may automatically and nearly instantly forward copies of that sensitive message to all entries in the BCC recipient's address book—before the recipient has a chance to stop it, and oftentimes without the recipient's knowledge it is being done.

As such, even if an author has total trust and confidence in a BCC recipient personally, the author must also have total trust and confidence in the software “sterility” or “cleanliness” of the BCC recipient's email server and client. This is not practical or ordinarily prudent, in most situations.

Therefore, there is a need in the art for a system and method which provides control by an author if an email message to how that message is used, forwarded, quoted, or replied by one or more recipients such as blind carbon copy recipients. Additionally, there is a need in the art for the new system and method to be compatible with widely used electronic mail protocols and client programs, in order to maximize usefulness of the invention.

### BRIEF DESCRIPTION OF THE DRAWINGS

The following detailed description when taken in conjunction with the figures presented herein provide a complete disclosure of the invention.

FIG. 1 shows the common arrangement of e-mail servers, client computers, and computer networks.

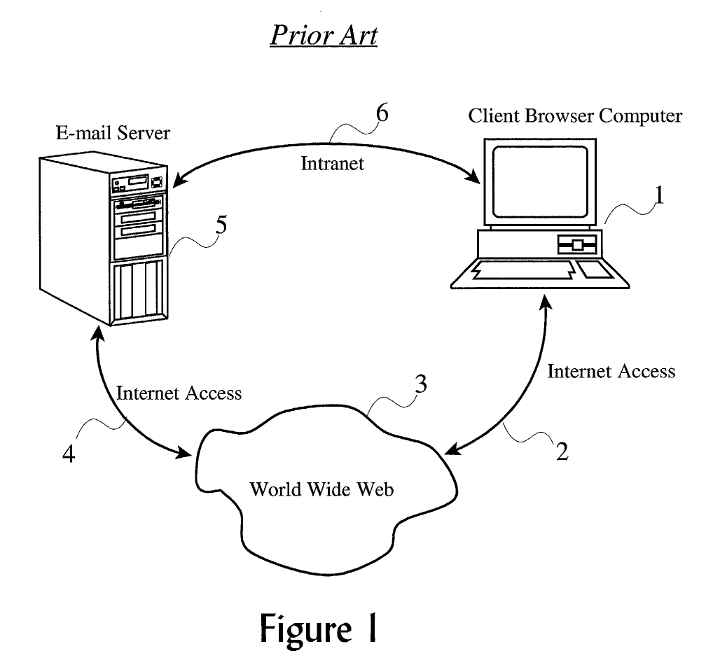

FIG. 2 shows the fundamental arrangement of e-mail sender and receiver servers.

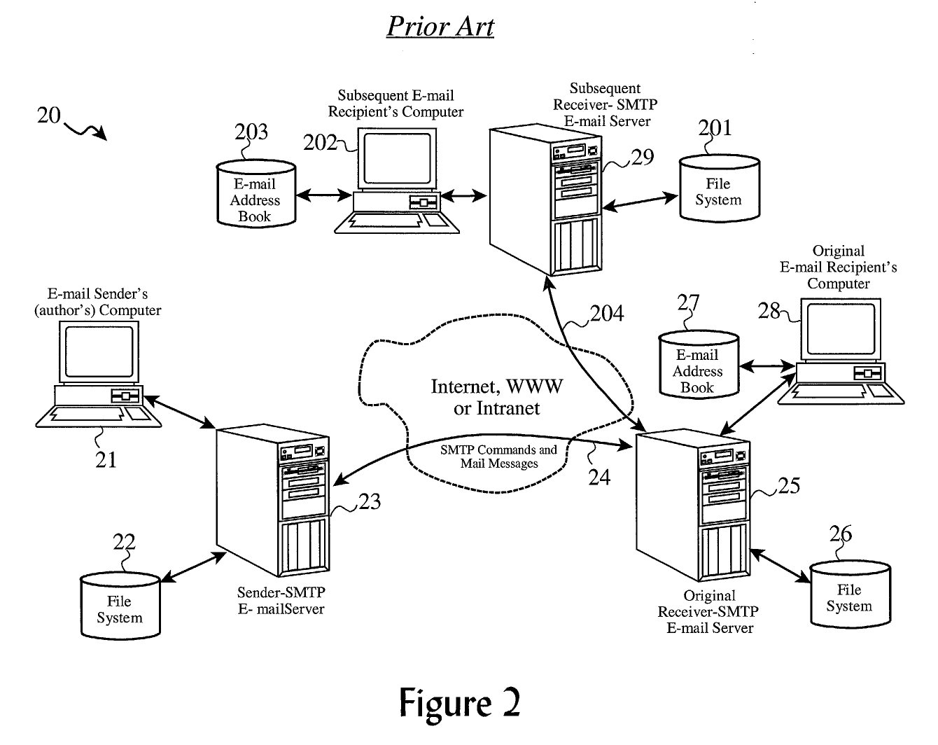

FIG. 3 depicts a generalized computing platform architecture, such as a personal computer, server computer, personal digital assistant, web-enabled wireless telephone, or other processor-based device.

FIG. 4 shows a generalized organization of software and firmware associated with the generalized architecture of FIG. 3.

FIG. 5 provides an illustration of the logical process of creating an enhanced electronic message with blind carbon copy controls according to the invention.

FIG. 6 shows the logical process of receiving, reviewing and handling controlled actions by a blind carbon copy message recipient according to the invention.

FIG. 7 illustrates the logical process of the invention for handling requests from blind carbon copy recipients to perform information dissemination actions which are controlled by the author.

### SUMMARY OF THE INVENTION

The invention provides control to an electronic message author to prevents undesired and unauthorized forwarding of blind carbon copy message by BCC recipients. The method of the invention provides a authoring control which prevents or authorizes forwarding of blind carbon copy emails by BCC recipients, and which optionally informs either or both the author and the BCC recipient of the control's status and the BCC recipient's attempted actions.

The control also is disclosed with several variants of embodiment, wherein the author may simply be notified of the forwarding of the BCC message by the BCC recipient, the author may block the forwarding of the BCC message, or the author may permit forwarding of the BCC message upon request by the BCC recipient.

In the first embodiment, the author may be notified that the trusted BCC recipient is forwarding messages sent to him or her under the BCC method, which may allow the author to learn more about the BCC recipient and adjust his or her trust level appropriately. In an enhanced version of this embodiment, the BCC recipient may not be aware that the author is being notified of his or her forwarding actions, which provides the author the ability to surveil (e.g. observe without the subject's awareness) the BCC recipients' actions without causing a change to the behavior of the recipient.

In the second embodiment, the author may simply block the BCC recipient from quoting, forwarding or “cutting-and-pasting” the message to another recipient. Preferably, when attempted, the BCC recipient would be notified of the disallowed action so that he or she could contact the author to request the author to send another copy to the person the BCC recipient would like to have a copy of the message.

In the third alternative embodiment, the attempt by the BCC recipient to forward the message to another recipient would actually result in a message back to the author, upon receipt of which the author could permit or authorize the delivery of the message to the additional recipient (and delivery conditions such as TO, CC, or BCC), or block the delivery. This embodiment may be done covertly, as well, to allow the author to not only surveil the activities of the BCC recipient, but also to control the actual dissemination of information by the BCC recipient covertly.

### DETAILED DESCRIPTION OF THE INVENTION

As blind carbon copy functionality is not ubiquitous to every email tool, the preferred embodiment integrates basic email functionality with a level of granularity to create a tool that be used across a wide variety of email clients.

A fundamental benefit of the invention is to provide an email author with a user interface control, such as a graphical user interface button, which allows a user to enjoy the benefit of BCC while knowing that their content will not be unknowingly or inadvertently forwarded to other parties. Our preferred embodiment is disclosed in two basic implementations, with specific implementation differences and options for each.

The methods of the invention are preferrably realized as software programs associated with or extending the functions of available electronic messaging functions of common computing platforms, such as e-mail clients (e.g. Netscape's Messenger™, Microsoft's Outlook™, Qualcomm's Eudora™, America Online's Instant Messenger™, etc.), and e-mail server systems (e.g. IBM's Lotus Notes). As these types of messaging functions are available on a wide variety of computing platforms ranging from two-way pagers to enterprise servers, it is useful to first review computing platforms in general. Common computing platforms can include enterprise servers and personal computers, as well as portable computing platforms, such as personal digital assistants (“PDA”), web-enabled wireless telephones, and other types of personal information management (“PIM”) devices.

Computing Platforms in General

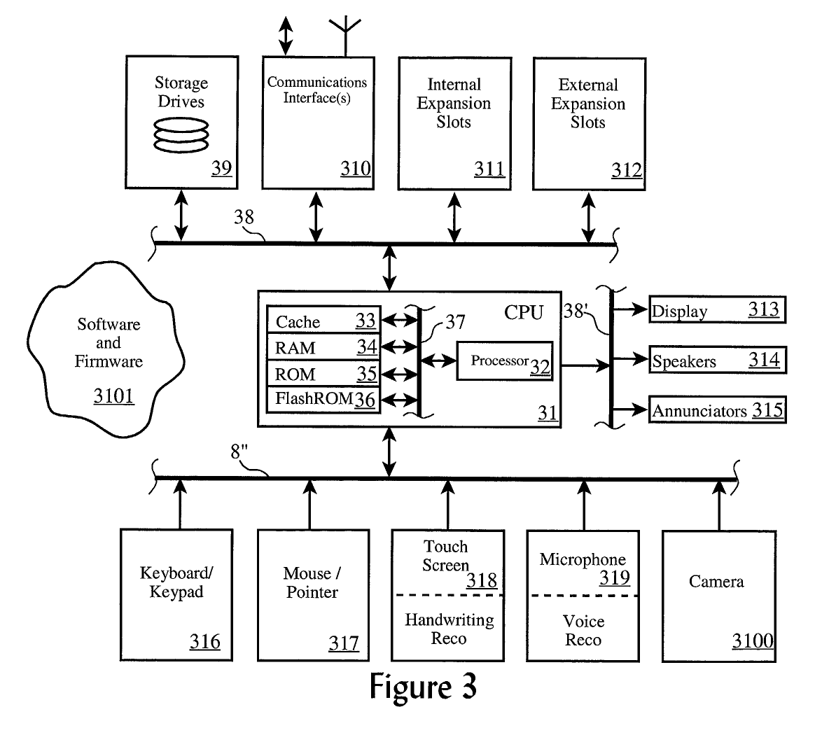

Turning to FIG. 3, a generalized architecture is presented including a central processing unit (31) (“CPU”), which is typically comprised of a microprocessor (32) associated with random access memory (“RAM”) (34) and read-only memory (“ROM”) (35). Often, the CPU (31) is also provided with cache memory (33) and programmable FlashROM (36). The interface (37) between the microprocessor (32) and the various types of CPU memory is often referred to as a “local bus”, but also may be a more generic or industry standard bus.

Many computing platforms are also provided with one or more storage drives (39), such as a hard-disk drives (“HDD”), floppy disk drives, compact disc drives (CD, CD-R, CD-RW, DVD, DVD-R, etc.), and proprietary disk and tape drives (e.g., Iomega Zip™ and Jaz™, Addonics SuperDisk™, etc.). Additionally, some storage drives may be accessible over a computer network.

Many computing platforms are provided with one or more communication interfaces (310), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (IrDA) interface, too.

Computing platforms are often equipped with one or more internal expansion slots (311), such as Industry Standard Architecture (ISA), Enhanced Industry Standard Architecture (“EISA”), Peripheral Component Interconnect (PCI), or proprietary interface slots for the addition of other hardware, such as sound cards, memory boards, and graphics accelerators.

Additionally, many units, such as laptop computers and PDA's, are provided with one or more external expansion slots (312) allowing the user the ability to easily install and remove hardware expansion devices, such as PCMCIA cards, SmartMedia cards, and various proprietary modules such as removable hard drives, CD drives, and floppy drives.

Often, the storage drives (39), communication interfaces (310), internal expansion slots (311) and external expansion slots (312) are interconnected with the CPU (31) via a standard or industry open bus architecture (38), such as ISA, EISA, or PCI. In many cases, the bus (38) may be of a proprietary design.

A computing platform is usually provided with one or more user input devices, such as a keyboard or a keypad (316), and mouse or pointer device (317), and/or a touch-screen display (18). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (318) is usually provided, often with handwriting recognition capabilities. Additionally, a microphone (319), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (3100), such as a still digital camera or full motion video digital camera.

One or more user output devices, such as a display (313), are also provided with most computing platforms. The display (313) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (314) and/or annunciators (315) are often associated with computing platforms, too. The speakers (314) may be used to reproduce audio and music, such as the speaker of a wireless telephone or the speakers of a personal computer. Annunciators (315) may take the form of simple beep emitters or buzzers, commonly found on certain devices such as PDAs and PIMs.

These user input and output devices may be directly interconnected (38′, 38″) to the CPU (31) via a proprietary bus structure and/or interfaces, or they may be interconnected through one or more industry open buses such as ISA, EISA, PCI, etc.

The computing platform is also provided with one or more software and firmware (3101) programs to implement the desired functionality of the computing platforms.

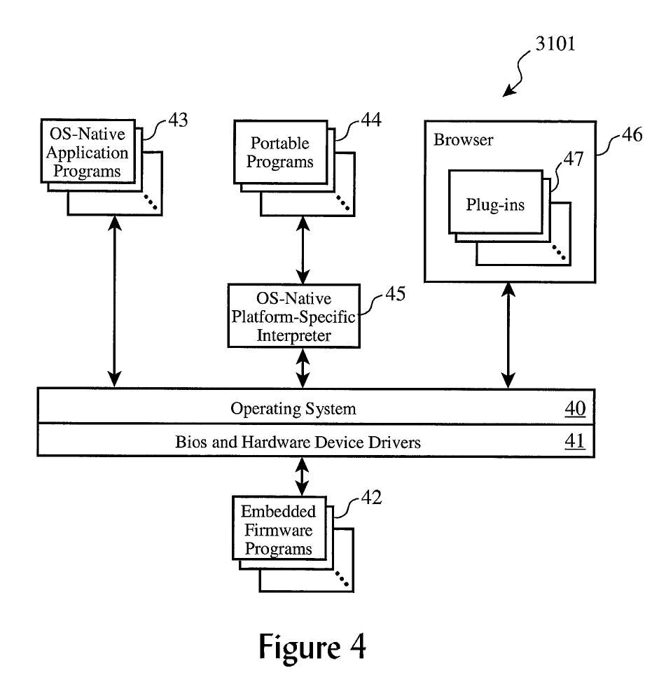

Turning to now FIG. 4, more detail is given of a generalized organization of software and firmware (3101) on this range of computing platforms. One or more operating system (“OS”) native application programs (43) may be provided on the computing platform, such as word processors, spreadsheets, contact management utilities, address book, calendar, email client, presentation, financial and bookkeeping programs.

Additionally, one or more “portable” or device-independent programs (44) may be provided, which must be interpreted by an OS-native platform-specific interpreter (45), such as Java™ scripts and programs.

Often, computing platforms are also provided with a form of web browser or “microbrowser” (46), which may also include one or more extensions to the browser such as browser plug-ins (47).

The computing device is often provided with an operating system (40), such as Microsoft Windows™, UNIX, IBM OS/2™, LINUX, MAC OS™ or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (41) are often provided to allow the operating system (40) and programs to interface to and control the specific hardware functions provided with the computing platform.

Additionally, one or more embedded firmware programs (42) are commonly provided with many computing platforms, which are executed by onboard or “embedded” microprocessors as part of the peripheral device, such as a micro controller or a hard drive, a communication processor, network interface card, or sound or graphics card.

As such, FIGS. 3 and 4 describe in a general sense the various hardware components, software and firmware programs of a wide variety of computing platforms, including but not limited to personal computers, PDAs, PIMs, web-enabled telephones, and other appliances such as WebTV™ units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

We now turn our attention to description of the methods of the invention and their associated components. It is preferrably realized as extensions to existing email authoring and reading software programs, such as a plug-in for Netscape's Messenger email client program. However, it will be recognized by those skilled in the art that the methods of the present invention may be employed and adopted in many other ways, such as a stand alone program, application service provider (“ASP”), or web mail function or servlet, without departing from the spirit and scope of the invention.

Method of the Present Invention

In a first aspect of the invention, a user-operable “button” or drop-down list option may be made available within an email client program's graphical user interface (“GUI”) to allow the author/sender of a message the option of controlling forwarding and replying functions by recipients who are listed in a blind copy field. The BCC control or options button may be activated or enabled by the action of the author entering an address into the BCC field, and may provide one or more of the following controls:

(a) disable any attempt to forward this message;

(b) disable any attempt to reply to this message;

(c) disable any attempt to “reply to all” recipients of this message;

(d) enable author notification that a user has attempted a forward action;

(e) enable author permission and authorization requirement before completing forward or reply actions; and

In the above options, when replying and forwarding actions are enabled or disabled, the preferred embodiment includes not only the “normal” actions available to a BCC recipient, such as simply selecting a “Forward” button on their own email client GUI, but also all actions which could lead to the user circumventing the control, such as:

(i) selecting and copying text via a clipboard (e.g. “cutting-and-pasting”);

(ii) capturing the screen buffer (e.g. “print screening”); and

(iii) saving the message to an alternate file format (e.g. text or hyper text markup language “HTML”).

As such, one possible embodiment for the invention is to provide a special email reader or plug-in which controls the BCC recipient's GUI for the duration of the viewing and reading of the file. In this manner, the plug-in may completely control what the BCC recipient may do with the message. Such a plug-in technology which allows the author to control file operations, clipboard operations, and screen buffer operations is Adobe's Acrobat Reader™. So, in an embodiment such as this, the author's email client program would be equipped with the capability to render an Adobe Portable Document Format (“PDF”) file of a message to be sent to each BCC recipient (with appropriate restrictions set), and each BCC recipient would “read” the message using an Acrobat Reader plug-in. Other similar technologies are readily available to use instead of the noted Acrobat technology, which is disclosed for illustrative purposes only.

Additionally, many of the options for control of the BCC recipient's actions just mentioned may be further defined by “covert” or “overt” notification options to the BCC recipient. For example, if option (a) is selected by the author (disabling any attempt to forward the message), a sub-option may include enabling notification to the author that the BCC recipient attempted but was denied the forwarding action. This sub-option may include further an option to allow the BCC recipient notification that the author has been notified of the attempted action. This allows the author maximum control not only on the actual successful actions of the BCC recipient, but also the ability to control what the BCC recipient knows of the process so that his or her behavior may be adjusted or unmodified according to the author's needs and wishes. If the author wants to know if a BCC recipient can truly be trusted, the author may select disabling of all forwarding with author-only notification (no BCC recipient notification), for example, which would allow the author to know of every attempt to forward a BCC'd message by the BCC recipient but not cause the BCC recipient to know his or her actions are being monitored.

Other author controls can be provided with such a “covert/overt” author notification option, with or without BCC recipient notification, as well.

The actual author GUI control may be provided as part of the persistent interface, or it may be provided as a “pop up” once the BCC field is filled completed. Additionally, the default state of these options being selected or de-selected may be predefined or configurable by the user so that the author may not have to set any options on most BCC'd messages.

In order to implement the new control, three alternative embodiments of the method are provided:

(1) provision of a special flag or indicator within the original email message, the flag being set by the author's email program and utilized by the BCC recipient's email program; and

(2) provision of a special message rendering function cooperative with the author's email program, and a special message reading function cooperative with the BCC recipients email program (e.g. Adobe Acrobat PDF Writer and Reader);

(3) provision of a special function embedding capability for the author's email composition software, a function execution capability for the BCC recipient's email reading software, and a permission/authorization server communicably disposed between the two.

According to the first embodiment alternative (addition of a special flag), the composed email may include a special flag such as shown in Table 4.

TABLE 4
Generalized Electronic Message Format
With BCC-Forwarding-Replying Control Flag

Received: from source by local_server; time_of_day
From: senders_name <senders_email_address>
Reply-to: <senders_email_address>
To: normal_recipients_name <normal_recipients_email_address>
BCC: BCC_recipients_name
Subject: text_of_the_subject_line
Content-type: type_of_content_such_as_MIME
BCC_Controls: <reply=OK, reply_all=NO, auth_notify=yes,

BCC_recip_notify=NO>

“Text of the actual message”

In this example, the author has enabled the BCC recipient to reply to the author normally, but disabled the BCC recipient's ability to “reply to all” other normal recipients (e.g. recipients in the “TO:” and “CC:” fields). The author has also selected author notification, so that the author will receive via email a notification if the BCC recipient attempts to perform a prohibited action. However, the author is disabled notification to the BCC recipient that the author is aware (or notified) of the attempted but rejected actions, thereby allowing the author to surveil the BCC recipient's behavior.

The status of the special flag is preferrably clearly displayed on the BCC recipient's GUI, alerting them to the enablement of the BCC no copy functionality. Additionally, “graying out” or otherwise disabling both the REPLY as well as FORWARD buttons on the BCC recipient's the Graphical User Interface (“GUI”) communicates this condition, as well.

Further, according to detection of the special flag, the BCC recipient's email client also takes the “focus” off the email, which disallows “cutting and pasting” of the text of the BCC message, and prevents any “screenshot” from being taken that later could be forwarded on as a graphic image (e.g. BMP, TIF, etc.). In any type of GUI or text environment, this secures the email against other methods of circumventing copy protection.

The second alternative embodiment, the invention provides a special message rendering function cooperative with the author's email program, and a special message reading function cooperative with the BCC recipients email program is provided. For example, the author's email client program may be provided with a plug-in which allows the author to create a special format data object or file, such as a PDF file, which has certain restricted actions available to the recipient, including restriction on saving the file, copying portions of the file or screen to a clipboard or screen print buffer, or even printing (to prevent subsequent scanning) options. Additionally, read-once options and one-time-use passwords can be employed to allow the BCC recipient to open and read the message only one time.

In the third alternative embodiment, a server is provided which can communicate with both the author's email client program and the BCC recipient's email client program such that the server can manage and authorize the BCC recipient's actions according to the author's wishes. This embodiment may be especially useful for server-based “web mail”. In this arrangement, the BCC recipient's email program would not be able to send or forward messages independently, but instead requests the server to send or forward message on its behalf. The server, then, is situated to notify the author of the BCC recipient's actions, and to either carry out or block the requested actions of the BCC recipient according to the author's BCC control settings.

Of course, it will be recognized by those skilled in that art that many combinations and variations of these three embodiment alternatives may be realized without departing from the spirit and scope of the present invention.

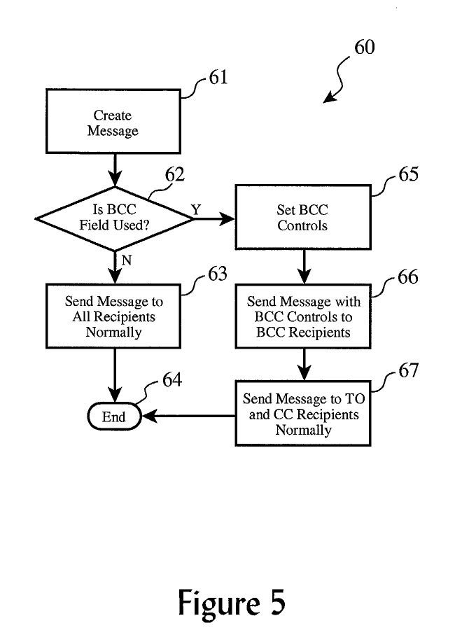

Turning now to FIG. 5, the logical process (60) according to the invention is shown for authoring an electronic message with controls on the actions of a BCC recipient. The author uses an email client program to create a message (61). If the BCC field is not completed (e.g. contains no recipient addresses), then the message is sent to all recipients normally (63), and the process ends (64).

However, if the BCC field is completed (62) with one or more BCC recipient addresses, then the author is presented with prompts or GUI controls (e.g. buttons, checklists, radio buttons, drop-down lists, etc.) to specify (65) which actions are to be permitted by the BCC recipients, which are to be blocked, and whether or not author notification, BCC recipient notification, or author permission request is to be performed. The enhanced message is then transmitted to the BCC recipients with the appropriate BCC controls set (66), and the normal message is transmitted to all other recipients.

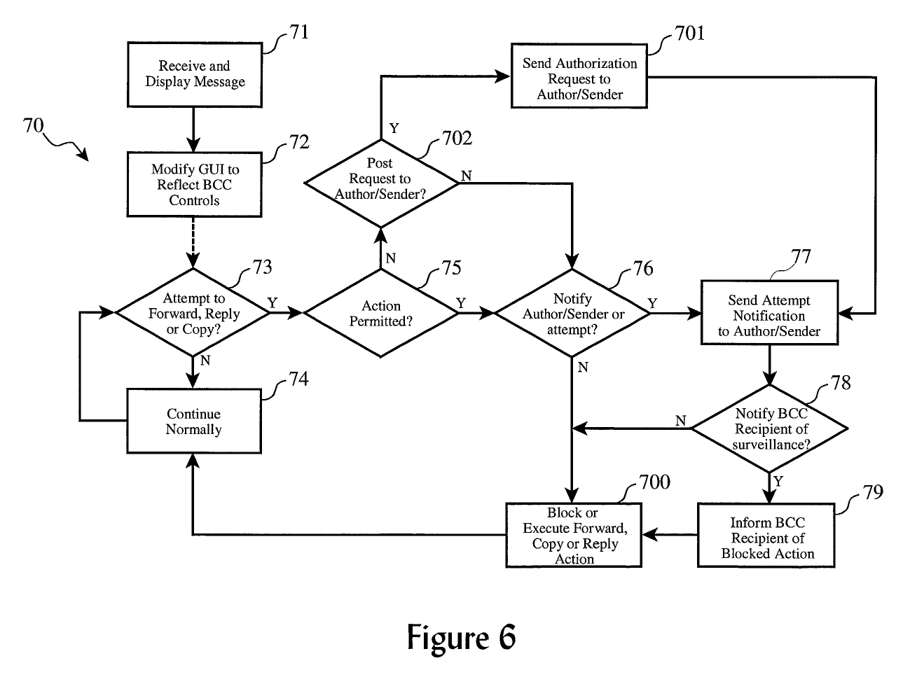

FIG. 6 shows the logical process (70) of receiving and reviewing an enhanced message by a BCC recipient. When the message is received (71), it is displayed and the GUI is modified to reflect the BCC controls, such as by “graying out” the REPLY-TO-ALL, REPLY, and/or FORWARD buttons, and optionally by displaying a BCC flag status indicator.

Reading and reviewing the message proceeds normally (74) until (73) the BCC recipient attempts to perform a restricted or controlled action, such as reply to the message, reply to all the recipients of the message, copy a portion of the text of the message, perform a screen print, save the message to a file, or print the file to paper (or to a print capture routine).

When a controlled action is attempted (73), if the action is outright permitted (75), then a notice may be sent (77) to the author of the action if (76) the author has selected the author notification option. Additionally, the BCC recipient may be notified (79) of the author's notification (e.g. a pop-up dialogue may provide an informational prompt indicating the action has been reported to the author), if (78) the BCC recipient notification option has been selected by the author. If (76) no notifications were selected by author, then the action is executed (700), and reading of the message continues normally (74).

However, if (75) the attempted action is not outright permitted, a check (702) is made to determine if the author might authorize the action upon request. If so, then a request is posted by email, preferrably, to the author of the attempted action, such as by sending the author a message saying:

“BCC_recipient_{—}#1 has attempted to forward your message to subsequent_forward_address. Select ‘APPROVE’ or ‘DECLINE’”

The request to the author preferrably contains the original text of the message so as to remind the author of the content of the message. The approve/decline choices may be received from the author by the author's email program by providing GUI buttons, hyperlinks in the request message (e.g. hyperlinking the text ‘approve’ and ‘decline’), or designating special keys (e.g. right mouse click, function keys, enter/end keys, etc.)

The BCC recipient's email program, however, would not typically receive an immediate response to the request, as email is generally a non-realtime or asynchronous method of duplex communications. So, the BCC recipient may be notified (79) of the request that has been posted to the author, if (78) that option has been selected by the author. The action is otherwise blocked (700) from immediate execution, and reading the message proceeds normally (74).

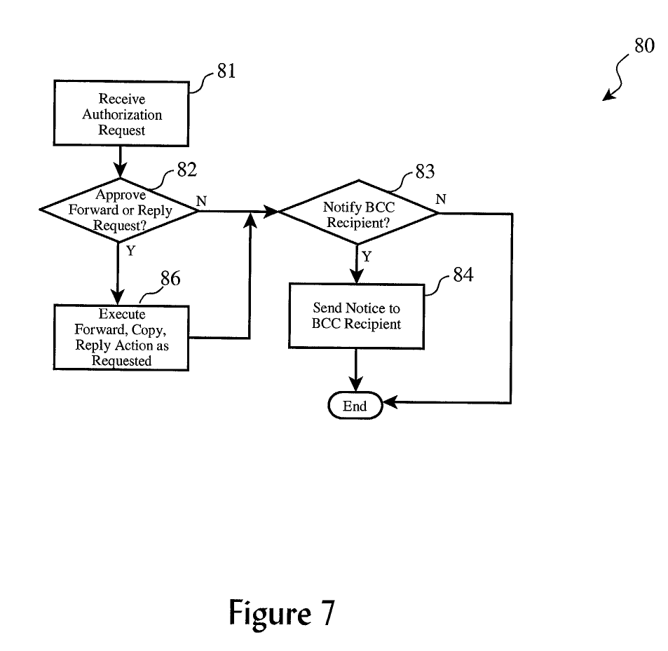

Now, we return to logical operations (80) on the author's email client program which commence upon the receipt (81) of an authorization request from a BCC recipient for a controlled action, as shown in FIG. 7. The message may be formatted and author inputs may be provided as previously disclosed.

If the author approves the request (82), the author's email client program may execute the request by forwarding the message directly to the subsequent recipient as requested by the BCC recipient. If the request was to print, reply, or save the message, the author's email program may then send back to the BCC recipient a copy of the original message with the BCC controls appropriately enabled to allow the requested action. Additionally, if the author so wishes (83), the BCC recipient may be notified (84) that the forwarding action has been performed on his or her behalf by the author, using a message such as:

“Your request on DAY-DATE-TIME to forward a message from AUTHOR has been approved, and the message has been forwarded to subsequent_foward_address for you by the AUTHOR”

If the author declines or requests the requested action, no action may be taken at all (effectively blocking the action), or the BCC recipient may be notified (84) of the declined request if the author has selected that option (83), using a message such as:

“Your request on DAY-DATE-TIME to forward a message from AUTHOR has been declined. For further explanation, please contact AUTHOR.”

Conclusion

The invention reduces the degrees of risk initially assumed by using email blind carbon copy functionality. It allows for an easier exchange of messaging without the traditional worries through increased security and improved control of the email system itself.

By ostensibly alerting the blind carbon copy recipients as well as the author of attempted actions, the invention helps to keep both parties secure that the transmission will terminate in the intended destinations. This allows trusted relationships to be built and maintained, and avoids potentially serious and costly loss of confidentiality in electronic message information. It may promote compliance with regulatory and other legal requirements, as well, such as dissemination of financial, political and defense-related information.

As such, it will be readily apparent to those skilled in the art that certain variations, subcombinations, and alternate embodiments may be taken without departing from the spirit and scope of the invention, including but not limited to adoption of alternate programming methodologies and computing platforms, messaging protocols, and user interface techniques. The scope of the invention should, therefore, be determined by the following claims.

What is claimed is:

1. A method for providing control of dissemination of information by blind carbon copy recipients in an electronic messaging system comprising the steps of:
providing an author-operable control associated with a blind carbon copy (“BCC”) message which indicates a control action to be performed upon attempt of dissemination of information contained in said BCC message by a BCC recipient;
transmitting said BCC message and associated control from an author to a BCC recipient; and
upon attempt by a BCC recipient to disseminate information contained in said BCC message, executing said control action.

2. The method as set forth in claim 1 wherein said step of executing said control action comprises detecting an attempt by said BCC recipient to perform a step selected from the group of forwarding the message, replying to the message, replying to other recipients of the message, copying text from the message, saving the message to another form, and printing the message.

3. The method as set forth in claim 1 wherein said step of executing said control action comprises sending a notification to said author of the BCC recipient's attempted dissemination.

4. The method as set forth in claim 3 wherein said step of executing said control action comprises providing a notice to said BCC recipient of the notice sent to said author regarding the BCC recipient's attempted dissemination.

5. The method as set forth in claim 1 wherein said step of executing said control action comprises providing a user interface indication to said BCC recipient of the status of said author-operable control.

6. The method as set forth in claim 1 wherein said step of executing said control action comprises the steps of:
sending a dissemination request to said author indicating a subsequent recipient's address or identity; and
upon approval of said request, performing said dissemination of information to said subsequent recipient.

7. A computer readable medium encoded with software for providing control of dissemination of information by blind carbon copy recipients in an electronic messaging system, said electronic message system having one or more processors capable of executing said software which performs the steps of:
providing an author-operable control associated with a blind carbon copy (“BCC”) message which indicates a control action to be performed upon attempt of dissemination of information contained in said BCC message by a BCC recipient;
transmitting said BCC message and associated control from an author to a BCC recipient; and
upon attempt by a BCC recipient to disseminate information contained in said BCC message, executing said control action.

8. The computer readable medium as set forth in claim 7 wherein said software for executing said control action comprises software for detecting an attempt by said BCC recipient to take perform a step selected from the group of forwarding the message, replying to the message, replying to other recipients of the message, copying text from the message, saving the message to another form, and printing the message.

9. The computer readable medium as set forth in claim 7 wherein said software for executing said control action comprises software for sending a notification to said author of the BCC recipient's attempted dissemination.

10. The computer readable medium as set forth in claim 9 wherein said software for executing said control action comprises software for providing a notice to said BCC recipient of the notice sent to said author regarding the BCC recipient's attempted dissemination.

11. The computer readable medium as set forth in claim 7 wherein said software for executing said control action comprises software for providing a user interface indication to said BCC recipient of the status of said author-operable control.

12. The computer readable medium as set forth in claim 7 wherein said software for executing said control action comprises software for performing the steps of:
sending a dissemination request to said author indicating a subsequent recipient's address or identity; and
upon approval of said request, performing said dissemination of information to said subsequent recipient.

13. An author control mechanism of dissemination of information by blind carbon copy recipients in an electronic messaging system comprising:
an author-operable control associated with a blind carbon copy (“BCC”) message which indicates a control action to be performed upon attempt of dissemination of information contained in said BCC message by a BCC recipient;
a transmission means for transmitting said BCC message and associated control from an author to a BCC recipient; and
a control action execution means for performing said control action upon attempt by a BCC recipient to disseminate information contained in said BCC message.

14. The mechanism as set forth in claim 13 wherein said control action execution means is adapted to detect an attempt by said BCC recipient to perform a step selected from the group of forwarding the message, replying to the message, replying to other recipients of the message, copying text from the message, saving the message to another form, and printing the message.

15. The mechanism as set forth in claim 13 wherein said control action execution means further comprises an author notification means for sending a notification to said author of the BCC recipient's attempted dissemination.

16. The mechanism as set forth in claim 15 wherein further comprising a BCC recipient notification means for providing a notice to said BCC recipient of the notice sent to said author regarding the BCC recipient's attempted dissemination.

17. The mechanism as set forth in claim 13 wherein said control action execution means comprises a user interface indication to said BCC recipient of the status of said author-operable control.

18. The mechanism as set forth in claim 13 wherein said control action execution means further comprises:
a dissemination request posting means for sending a request to said author indicating a subsequent recipient's address or identity; and
an information dissemination means for performing said dissemination of information to said subsequent recipient upon approval of said request.
